(19) United States
(12) Patent Application Publication
(10) Pub. No.: US 2006/0250544 A1
(43) Pub. Date: Nov. 9, 2006

(54) Surface light source device of side light type and liquid crystal display

(76) Inventor: Shingo Ohkawa, Koshigaya-shi (JP)

Correspondence Address: STAAS & HALSEY LLP, SUITE 700, 1201 NEW YORK AVENUE, N.W., WASHINGTON, DC, 20005, US

(21) Appl. No.: 11/401,941

(22) Filed: Apr. 12, 2006

Related U.S. Application Data
(62) Division of application No. 09/273,448, filed on Mar. 22, 1999.

(30) Foreign Application Priority Data
Mar. 25, 1998 (JP) 76811/1998
Jun. 16, 1998 (JP) 167634/1998

(51) Int. Cl. G02F 1/1335

(52) U.S. Cl. 349/65

(57) ABSTRACT

A LCD panel LP of LCD 2 is illuminated by a surface light source device of side light type 1 for backlighting. The surface light source device 1 comprises a plurality of sets each of which consists of a primary light source and a guide plate. When a fluorescent lamp 11A is turned on, illumination light LA is introduced into the guide plate 7A and then emitted from an emission face 7AO to be transferred to another guide plate 7B. A back face 7AR is provided with projection rows which prevent illumination light from being diverged toward right and left directions as viewed from an incidence end face 7A. Light transferred to the guide plate 7B is emitted from an emission face 7BO to directions inclined forward (LA1). A prism sheet 9 converts this into output illumination light LA2, which illuminates the LCD panel LP through a light diffusion sheet 10. When another fluorescent lamp 11B is turned on, illumination light LB is introduced into the guide plate 7B and then emitted from the emission face 7BO to directions inclined forward (LB1). The prism sheet 9 converts this into output illumination light LB2, which illuminates the LCD panel LP through the light diffusion sheet 10. A driving circuit 4 provides driving current control (including optional on/off control) for the fluorescent lamps 11A, 11B. Diverse directivity characteristics are realized depending on inclination angles of prismatic slopes of the prism sheet disposed along the emission face 7BO. For instance, optional output to one or both of different two directions.

### BACKGROUND

1. Field of Invention

The present invention relates to a surface light source device of side light type and to a liquid crystal display to which the light source device is applied, in particular, to a surface light source device employing a plurality of sets each of which is consisting of a primary light source and a guide plate and to a liquid crystal display provided with a backlighting arrangement to which the light source device is applied.

2. Related Art

A surface light source device of side light type is well known as a device to output illumination flux having a large cross section, being applied to backlighting of a liquid crystal display. A surface light source device of side light type arranged for backlighting supplies illumination light to a liquid crystal display panel from its back side.

In general, a surface light source device of side light type comprises a guide plate and a primary light source. One of major faces of the guide plate provides an emission face and the other provides a back face. The primary light source is disposed beside an incidence end face of the guide plate for supplying primary light to the guide plate through the incidence end face. This arrangement matches with a thin overall shape. A rod-shaped light source such as a cold cathode lamp is usually employed as the primary light source. Occasionally, point-like light sources such as LEDs (Light Emitting Diodes) are employed. Illumination light emitted from the primary light source is introduced into the guide plate through the incidence end face. Thus introduced illumination light propagates within the guide plate while outputting illumination light from the emission face of the guide plate.

Typically known guide plates include a flat-plate-like guide plate with an overall uniform thickness and a guide plate with a wedge-shaped cross section. The former employed, primary light is supplied to the guide plate through one or more end faces (minor faces). The latter employed, primary light is supplied to the guide plate through a thicker-side end face. Such end faces through which primary light is supplied are called “incidence end faces”.

A typical primary light source for supplying primary light is a rod-shaped light source such as a cold cathode lamp (fluorescent lamp). It is also known to employ point-like light sources as LEDs as a primary light source.

Illumination light is emitted from the emission face which is provided by one of major faces of the guide plate. It is known that this emission has, in general, a principal direction (i. e. preferential emission direction) which is inclined forward regarding in a plane perpendicular to the incidence end face (i. e. as approaching primary light supply direction). A light control member such as a prism sheet mya be arranged along the emission face in order to correct this inclination so that a frontal illumination output is produced.

A surface light source device of side light type which provides a powerful illumination output is desired for application to backlighting of LCD, for example, employed in car navigation system. And it is further desired that intensity of illumination output is adjustable over a wide range.

This is because the optimum brightness of display varies depending on conditions such as in the daytime or nighttime, in fine weather or rainy weather. For instance, driving in the fine daytime demands that backlighting is supplied with very strong illumination output to overcome strong ambient daylight. To the contrary, drivers in the nighttime prefers rather weak illumination output because strong illumination output would let backlighting produce an undesirably glaring display.

Depending on uses, illumination output with dual directivity is demanded from a surface light source device of side light type. For example, in the case of LCD in car navigation system, bright display is requested by a driver, an assistant sitting next to him or both of them depending on the situation.

This directivity is desired to be changeable depending on the situation of use. For instance, when one of the driver and the assistant solely sees the LCD, only one effective preferential emitting direction suffices. And when both of the driver and the assistant see the LCD, both preferential emitting directions is requested to be effective.

Prior arts seem to fail to provide a surface light source device of side light type and a LCD which are capable of satisfying such requests and demands and are simply structured. Although a prior art surface light source device is supplied with light through both incidence end faces of a single guide plate, the above requests and demands are not well satisfied.

### OBJECT AND SUMMARY OF INVENTION

An general object of the present invention is to provide a surface light source device of side light type and a liquid crystal display which are capable of satisfying the above-described requirements or demands well.

An object of the present invention is to provide a surface light source device of side light type which allows intensity of illumination output to be adjustable in a wide range. And another object of the present invention is to apply the surface light source device to a liquid crystal display so that the display realizes a good display performance regardless of circumstance easily.

A still another object of the present invention is to provide a surface light source device of side light type which capable of giving illumination output with dual directivity. And still one more object of the present invention is to apply such a surface light source device to a liquid crystal display so that the display performs displaying which is suitable for viewing from different two directions, in particular, from any one of them.

A surface light source device of side light type in accordance with the present invention comprises a first guide plate, a first primary light source disposed beside the first guide plate, a second guide plate, a second primary light source disposed beside the second guide plate and a driving circuit to drive the first primary light source and the second primary light source.

The first guide plate has two major faces to provide a first emission face and a first back face while the first guide plate has a minor face to provide a first incidence end face; and the second guide plate has two major faces to provide a second emission face and a second back face while the second guide plate has a minor face to provide a second incidence end face, wherein the first guide plate and the second guide plate are laminatedly disposed so that the second back face is arranged along the first emission face.

And the first incidence face and the second incidence face are located oppositely to each other across the laminatedly arranged guide plates while a light control member for controlling directivity of illumination output is disposed along the second emission face. The driving circuit is preferably capable of turning off only one in the first and second primary light sources.

The first and second guide plates are preferably have wedge-like cross sections so that the first and second incidence end faces are set at thicker ends of the wedge-like cross sections, respectively.

Further, it is preferable that the first back face is provided with a great number of projection rows each of which includes a pair of slopes running approximately at right angle angles with respect to the first incidence end face.

An arrangement suitable for a case where dual directivity is not required employs a light control member which modifies directivity so that illumination output light originated from any one of the first and second primary light sources is directed to a frontal direction with respect to the second emission face.

A typical light control member employed in this case has an inner face provided with a great number of projection rows each of which includes a pair of slopes running approximately in parallel with the second incidence end face.

In a typical embodiment, the first primary light source and the second primary light source are rod-like light sources disposed approximately in parallel with each other longitudinally.

The above-described and other features of the present invention will be well understood from the following detailed description on embodiments with referring to the accompanied drawings.

### BRIEF DESCRIPTION OF DRAWING

FIG. 1 is an exploded perspective view of a LCD in accordance with a first embodiment;

FIG. 2 is a cross sectional view of the arrangement shown in FIG. 1;

FIG. 3 is a graph illustrating directional characteristics of illumination light measured under a condition such that the employed prism sheet is removed from the first or forth embodiment with the first primary light source being turned on solely;

FIG. 4 is a graph illustrating directional characteristics of illumination light measured under a condition such that the employed prism sheet is removed from the first or forth embodiment with the second primary light source being turned on solely;

FIG. 5 is a graph illustrating directional characteristics of illumination light measured under a condition such that the employed prism sheet is removed from the first or forth embodiment with the first and second primary light sources being both turned on;

FIG. 6 is a cross sectional diagram to illustrate functions of a prism sheet employed in the first embodiment;

FIG. 7 is a graph illustrating directional characteristics of illumination light measured under a condition such that the first primary light source is turned on solely in the first embodiment;

FIG. 8 is a graph illustrating directional characteristics of illumination light measured under a condition such that the second primary light source is turned on solely in the first embodiment;

FIG. 9 is a graph illustrating directional characteristics of illumination light measured under a condition such that the first and second primary light sources are both turned on in the first embodiment;

FIG. 10 is a cross sectional diagram to illustrate an arrangement in which one guide plate is supplied with primary light from a plurality of light source elements;

FIG. 11 is an exploded perspective view to illustrate an arrangement in which three or more guide plates are employed;

FIG. 12 is an exploded perspective view of a LCD in accordance with a second embodiment;

FIG. 13 is a cross sectional view of the arrangement shown in FIG. 12;

FIG. 14 is a cross sectional diagram to illustrate functions of a prism sheet employed in the second embodiment;

FIG. 15 is a graph illustrating directional characteristics of illumination light measured under a condition such that the first primary light source is turned on solely in the second embodiment;

FIG. 16 is a graph illustrating directional characteristics of illumination light measured under a condition such that the second primary light source is turned on solely in the second embodiment;

FIG. 17 is a graph illustrating directional characteristics of illumination light measured under a condition such that the first and second primary light sources are both turned on in the second embodiment;and,

FIG. 18 is an exploded perspective view to illustrate another arrangement in which three or more guide plates are employed.

### EMBODIMENT

### (1) First Embodiment

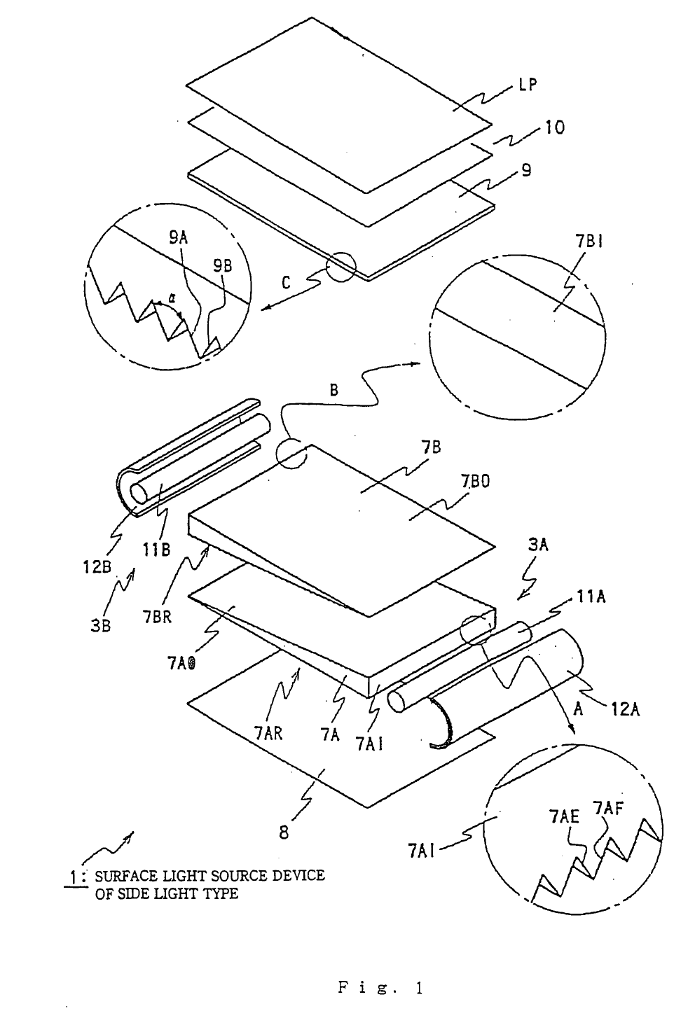

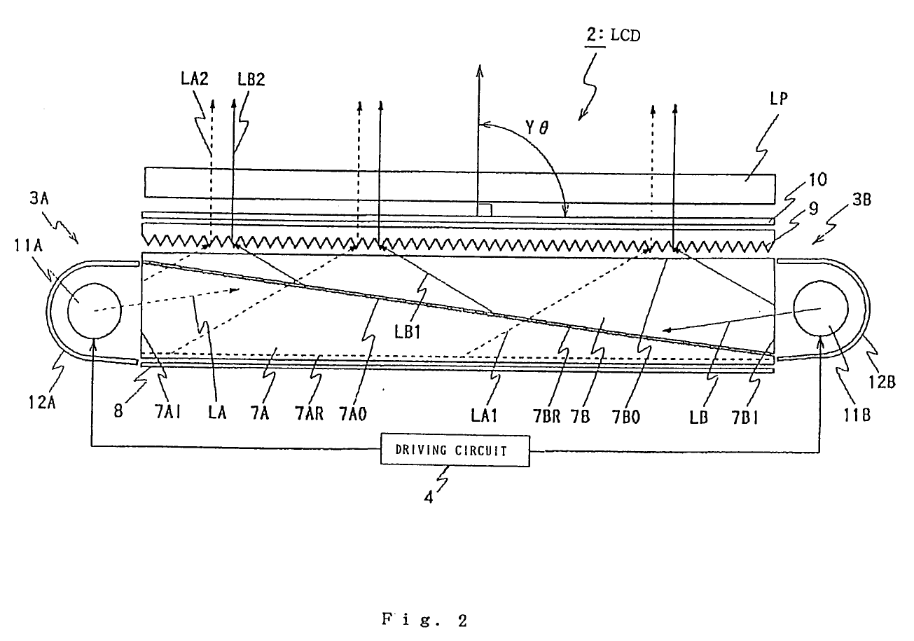

Referring to FIGS. 1 and 2, a surface light source device of side light type 1 is arranged for backlighting of a LCD panel (liquid crystal display panel) to constitute a liquid crystal display 2 (FIG. 2). The liquid crystal display 2 is applied to, for example, a display in car navigation system. The surface light source device 1 comprises first and second guide plates 7A, 7B as well as first and second primary light sources 3A, 3B, correspondingly, with a driving circuit 4 to drive the light sources.

The guide plates 7A, 7B are made of scattering-guiding material. Scattering-guiding material is material having scattering power within itself and, for example, consists of matrix such as polymethyl methacrylate (PMMA) and “particles of different refractive index” which are uniformly dispersed in the matrix. Light permeable particles having refractive index different from that of the matrix are employed as “particles of different refractive index”.

Two major faces of the first guide plate 7A provide an emission face (first emission face) 7AO and a back face (first back face) 7AR. Two major faces of the second guide plate 7B provide an emission face (second emission face) 7BO and a back face (second back face) 7BR.

The first and second guide plates 7A, 7B arranged laminatedly so that the second back face extends along the first emission face. In the present embodiment, the first and second guide plates 7A, 7B have the same wedge-like cross section, respectively, and are arranged so that the first emission face 7AO extends along the second back face 7BR. The first emission face 7AO and the second back face 7BR provide slopes of approximately the same area, which are disposed face to face across a thin air layer. Such an arrangement gives compactibility and uniform thickness to the overall structure.

A minor face of the first guide plate 7A provides a first incidence end face 7AI; and a C minor face of the second guide plate 7B provides a second incidence end face 7B1, as indicated with circle B in FIG. 1. The first incidence end face 7AI and the second incidence end face 7B1 are located oppositely to each other across both guide plates.

The primary light sources 3A, 3B comprise emitting source elements such as rod-like fluorescent lamps 11A, 11B backed by reflectors 12A, 12B which have openings directed to the incidence end faces 7AI, 7B1, respectively. The reflectors 12 A, 12B are made of, for example, a sheet-like member having regular or irregular reflectivity.

The driving circuit 4 is equipped with an inverter and supply one or both of the fluorescent lamps 11A, 11B with electric power. Power supply is variable continuously or discretely. One of the lamps is optionally to be in turned-on-state with the other lamp being in turned-off-state while both lamps are allowed to be in turned-on-state or to be in turned-off-state.

The fluorescent lamp 11A is disposed along the incidence end face 7AI and the fluorescent lamp 11B is disposed along the incidence end face 7B1. One or both of the fluorescent lamps 11A, 11B supply one or both of the guide plates 7A, 7B with primary light depending on operation mode of the driving circuit 4.

As indicated with circle A in FIG. 1, the first back face is provided with a great number of projection rows. Each of the projection rows includes a pair of slopes 7AE, 7AF running approximately at right angles with respect to the first incidence end face 7AI.

These slopes 7AE, 7AF function so that directivity (preferential emitting direction) of illumination output from the emission face 7AO (accordingly, from the emission face 7BO) is gathered toward a frontal direction regarding in a plane parallel with the incidence end face 7AI. Besides, improvement in emission efficiency is realized because emission from the emission face 7AO occurs after less times of inside reflections as compared with a provisional case where the back face 7AR is a flat face (without slopes 7AE, 7AF).

A reflection sheet 8 is disposed along the first back face 7AR. The reflection sheet 8 is made of, for example, metal foil with regular reflectivity or white PET film with irregular reflectivity. This reflection sheet 8 reflects light which has leaked from the back face 7AR to return light into the guide plate 7A, thereby preventing loss of light energy.

A prism sheet employed as a light control member is a sheet-like member made of light permeable material such as polycarbonate. The prism sheet 9 is disposed along the second emission face 7BO with orientation such that a prism face is directed to the emission face 7BO. The prism face is provided with a great number of projection rows.

As indicated with circle C in FIG. 1, each of the projection rows includes a pair of slopes 9A, 9B running approximately in parallel with respect to the incidence end face 7B1. Each pair of slopes are directly connected to give a triangular-like cross section to each projection row. This prism sheet 9 modifies directivity regarding in a plane perpendicular to the incidence end face(s) 7B1 (and 7AI). Detail of modifying effect is described later. Output light from the prism sheet 9 irradiates a LCD panel LP via a light diffusion plate 10.

The light diffusion plate 10 is provided with weak scattering power, causing illumination light to have an increased mildness and a relaxed directivity with less sharpness. Another function of the light diffusion plate is to prevent such things as a great number of projection rows formed on the prism sheet 9 and on the back face 7AR or an brightened edges of the guide plate 7B from being conspicuous.

Scattering pattern for promoting emission from the guide plate 7A or 7B is formed preferably on one or both of the emission faces 7AO and 7BO. Such scattering pattern uniformizes intensity of emission from the emission faces 7AO, 7BO.

The scattering pattern is formed so that it is almost invisible when viewed from above the emission face 7AO or 7BO. For instance, the scattering pattern may consist of a great number of dot-like fine rough surface areas each of which is not larger than 80 μm. The fine rough surface areas are distributed preferably according to an arrangement provided with irregularity. This is because such an irregular arrangement prevents Moire fringes, which would be generated with relation to a periodic structure (e, g, electrode array) of the LCD panel LP, from being generated.

On lighting of the fluorescent lamp 11A, illumination light LA is introduced into the guide plate 7A and propagates toward a distal end at an thinner side. This process involves repeated reflections by the emission face 7AO and by the back face 7AR as well as scattering by inside scattering power and by scattering power of the scattering pattern formed on the emission face 7AO.

Component which has cleared the critical angle condition at inner incidence to the emission face 7AO is emitted from the emission face 7AO, impinging onto the guide plate 7B. The back face 7BR preferably has a specular surface to heighten efficiency of light transmission from the first guide plate 7A to the second guide plate 7B.

As aforedescribed, a great number of pairs of slopes 7AE, 7AF formed on the back face 7AR function so that directivity (preferential emitting direction) of illumination output from the emission face 7AO is gathered toward a frontal direction regarding in a plane parallel with the incidence end face 7AI through actions such as inner reflections. Thus modified directivity is generally maintained after passing through the guide plate 7B. Accordingly, directivity of illumination output from the emission face 7BO is gathered toward a frontal direction regarding in a plane parallel with the incidence end face 7AI or 7BI.

It should be noted that directions of emission from the emission face 7AO is greatly inclined forward (toward the incidence end face 7BI) regarding in a plane perpendicular to the incidence end face 7AI or 7BI.

Such directivity is generally maintained after passing through the guide plate 7B. Accordingly, directivity of illumination output from the emission face 7BO is

Accordingly, directivity of illumination output is greatly inclined forward (toward the incidence end face 7BI) regarding in a plane perpendicular to the incidence end face 7AI or 7BI.

Next, provided that the fluorescent lamp 11B is turned on, illumination light LB is introduced into the guide plate 7B and propagates toward a distal end at an thinner side. This process involves repeated reflections by the emission face 7BO and by the back face 7BR as well as scattering by inside scattering power.

Component which has cleared the critical angle condition at inner incidence to the emission face 7BO is emitted from the emission face 7BO. Although a small quantity, some light is introduced into the guide plate 7A via the back face 7BR. Almost all of such light is emitted again from the emission face 7AO to be returned into the guide plate 7B via various routes.

It should be noted that light supply from the fluorescent lamp 11B causes the emission face 7BO to output emission which is greatly inclined forward (toward the incidence end face 7AI) regarding in a plane perpendicular to the incidence end face 7BI.

That is, at emitting from the emission face 7BO, light originated from the fluorescent lamp 11A and light originated from the fluorescent lamp 11B are greatly inclined oppositely to each other with respect to a normal to the emission face 7BO (i. e. with respect to a frontal direction) regarding in a plane perpendicular to the incidence end face 7AI or 7BI.

For the sake of convenience, the former is represented by beam LA1 and the latter is represented by beam LB1. In the illustrated example, inclination angles of LA1 and LB1 with respect to the emission face 7BO are both about 23 degrees. Beams LA1, LB1 become beams LA2, LB2 after transmitting through the prism sheet 9, respectively. That is, the surface light source device 1 outputs beam LA2 solely when only the fluorescent lamp 11A is turned on while beam LB2 is outputted solely when only the fluorescent lamp 11B is turned on. If the fluorescent lamps 11A and 11B are both turned on, beams LAZ and LB2 are both outputted.

In order to check the emission beams represented by LA1 and LB1 for directivity, measurement has been carried out according to the following manners.

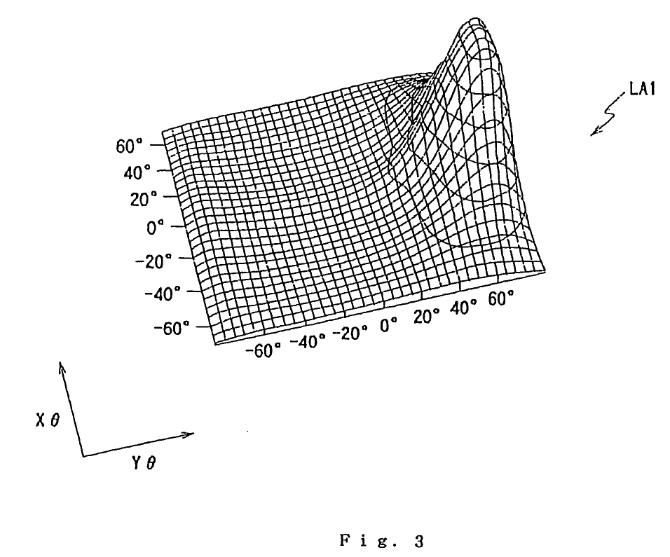

First and foremost, directional characteristics of illumination light emitted from the emission face 7BO has been measured under a condition such that the prism sheet 9 is removed from the first embodiment with the fluorescent lamp 11A (first primary light source) being turned on solely. Results are graphed in FIG. 3.

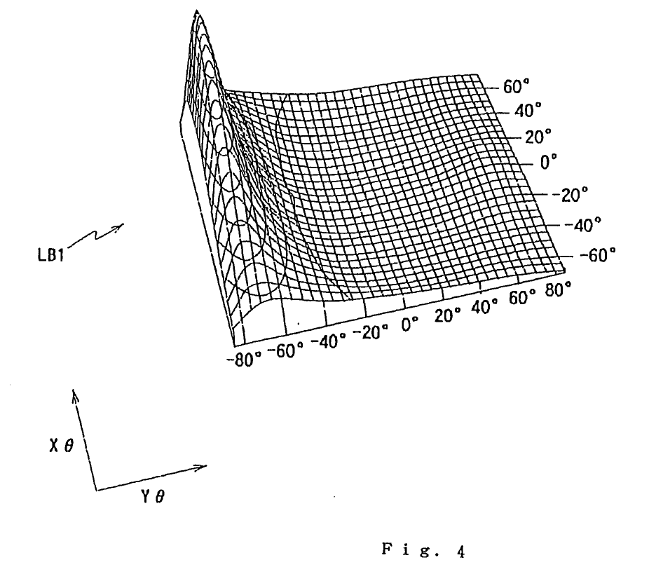

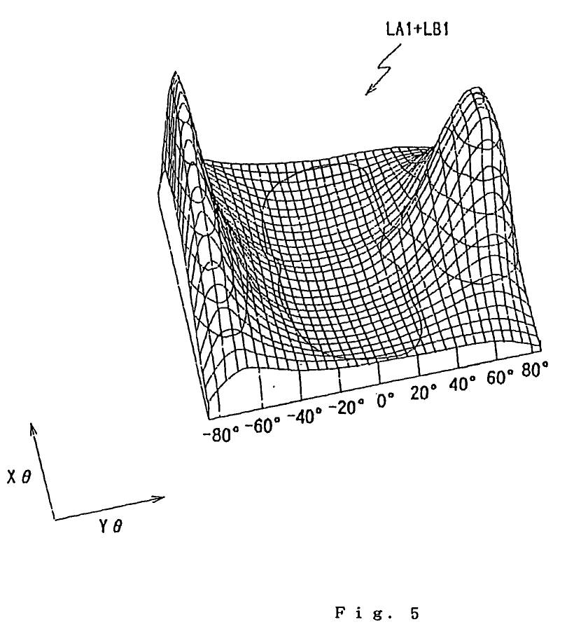

In a similar way, results as graphed in FIG. 4 have been obtained in a case where measurement has been performed under a condition such that the prism sheet 9 is removed with the fluorescent lamp 11B (second primary light source) being turned on solely. And results as graphed in FIG. 5 have been obtained in a case where measurement has been performed under a condition such that the prism sheet 9 is removed with the fluorescent lamps 11A and 11B (first and second primary light sources) being both turned on.

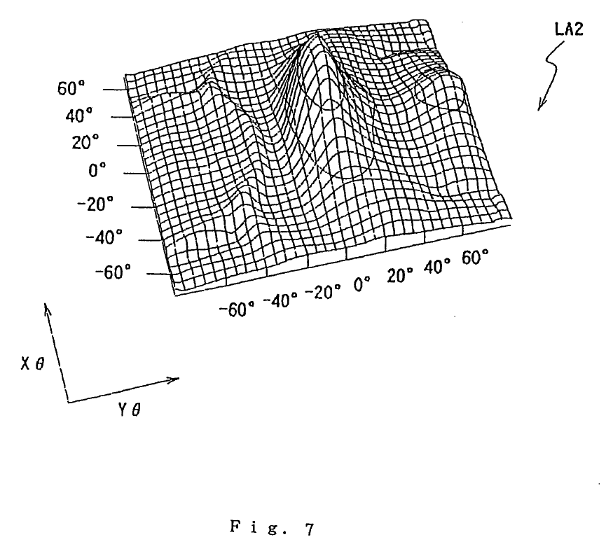

In these graphs and other graphs referred to later (FIGS. 7 to 9 and FIGS. 15 to 17), Y-direction is defined as a longitudinal direction of the guide plate 7B and X-direction is defined as a direction along the incidence end face 7BI, in relation to a normal with respect to the emission face 7BO of the guide plate 7B.

Angle for defining directions regarding in a plane parallel with the incidence end face 7AI is expressed by X θ while angle for defining directions regarding in a plane perpendicular to the incidence end face 7AI is expressed by Y θ. Sign of X θ is defined so that plus corresponds to the left hand and minus corresponds to the right hand as viewed from the incidence end face 7AI. Sign of Y θ is defined so that plus corresponds to forward and minus corresponds to backward as viewed from the incidence end face 7AI. A normal direction with respect to the emission face 7BO corresponds to X θ=Y θ=0. Intensity of light is plotted as variation of height from X θ-Y θ plane.

As understood from the results shown in FIGS. 3 and 4, directivity of illumination light represented by LA1 is inclined toward the right hand in FIG. 2 while that of illumination light represented by LB1 is inclined toward the left hand in FIG. 2. This is also understood from two ridge-like hills illustrated in the graph of FIG. 5. Needless to say, the graph of FIG. 5 corresponds to the sum of the graphs of FIGS. 3 and 4.

Attention should be paid to a fact that two ridge-like hills in FIG. 5 appear around angular positions which are symmetrically opposite with respect to a frontal direction (X θ=0), respectively. One ridge corresponds to LA1 and the other ridge corresponds to LB1.

Therefore, if it is realized to deflect both of LA1 and LBA1 toward the frontal direction (X θ=0)), illumination light emitting preferentially toward approximately the frontal direction (LA2, LB2 and LA2+LB2) is obtained under any one of conditions, sole lighting of the fluorescent lamp 11A, sole lighting of the fluorescent lamp 11B and lighting of both fluorescent lamps 11A, 11B.

An employable prism sheet 9 performs such deflection operation. In the present embodiment, prism vertical angle α made by a couple of slopes 9A, 9B is set at about 66 degrees in order to deal with the results shown in FIGS. 3 to 5. Inclination angles (angles with respect to a general plane representing the prism sheet 9) of the slopes 9A, 9B are equal to each other (inclination angles=57 degrees).

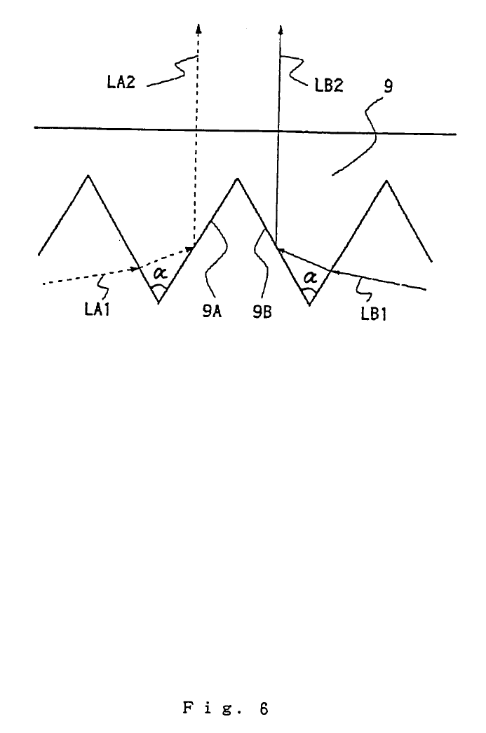

As illustrated in FIG. 6, illumination light LA1 is introduced into the prism sheet 9 through the slope 9B and then reflected by the slope 9A to be outputted toward around a frontal direction as illumination light LA2. In a similar way, illumination light LB1 is introduced into the prism sheet 9 through the slope 9A and then reflected by the slope 9B to be outputted toward around a frontal direction as illumination light LB2.

The optimum value of prism vertical angle α will vary within a certain extent depending on factors such as directional characteristics of illumination light LA1, LB1 (angular positions of the ridges in FIG. 5) and refractive index of the prism sheet 9. In general, prism vertical angle α can be set according to design based on measurements as described above and calculations (Snell's Law).

Functions of the prism sheet 9 employed in the present case are understood well from the graphs shown in FIGS. 7 to 9. FIG. 7 is a graph illustrating directional characteristics of illumination light measured under a condition such that the fluorescent lamp 11A (first primary light source) is turned on solely in the first embodiment. In other words, directional characteristics of output light of the prism sheet 9 is measured after the prism sheet 9 is added to the arrangement which has provided the results as shown in FIG. 3.

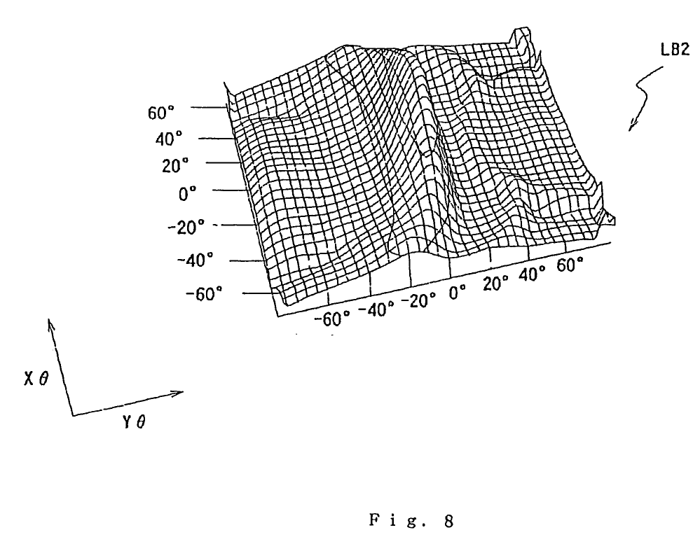

In a similar way, FIG. 8 is a graph illustrating directional characteristics of illumination light measured under a condition such that the fluorescent lamp 11B (second primary light source) is turned on solely in the first embodiment. That is, directional characteristics of output light of the prism sheet 9 is measured after the prism sheet 9 is added to the arrangement which has provided the results as shown in FIG. 4.

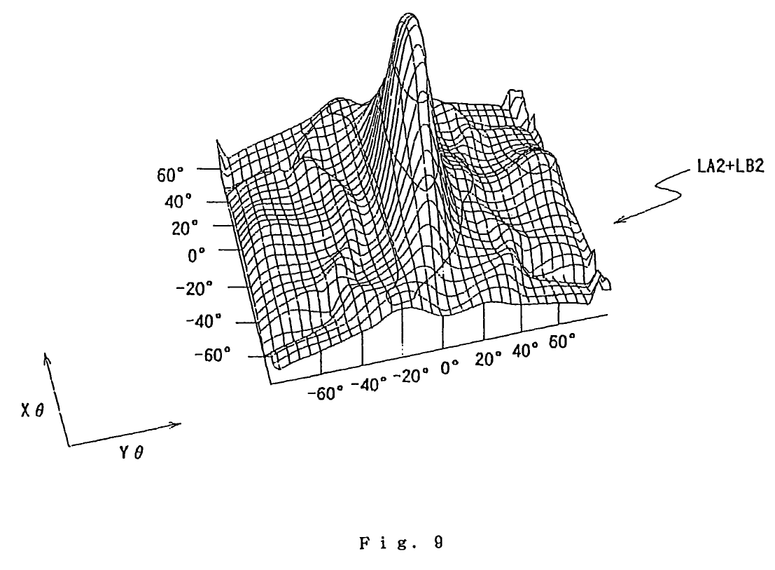

And FIG. 9 is a graph illustrating directional characteristics of illumination light measured under a condition such that both fluorescent lamps 11A, 11B (first and second primary light sources) are turned on in the first embodiment. That is, directional characteristics of output light of the prism sheet 9 is measured after the prism sheet 9 is added to the arrangement which has provided the results as shown in FIG. 5.

It is doubtless that any one of FIGS. 7 to 9 gives a graph in which a peak corresponding to around the normal direction is plotted. It should be noted that plotting of height from X θ-Y θ for indicating light intensity is carried out in FIGS. 7 to 9 at a smaller rate compared with in FIGS. 3 to 5.

While the driving circuit 4 is lighting both fluorescent lamps 11A, 11B, illumination light LA2 and illumination light LB2 illuminate the LCD panel LP through the light diffusion plate 10. While only one of the fluorescent lamps 11A, 11B is being lighted, only one of illumination light LA2 and illumination light LB2 illuminates the LCD panel LP through the light diffusion plate 10.

However, it should be noted that backlighting is performed with almost the same directional characteristics in every operation mode. Accordingly, image displaying suitable for viewing from around the frontal direction is realized. And, if electric current supplied to one or both of the fluorescent lamps 11A, 11B is changed, optional adjusting of screen brightness in a very wide range is achievable. It belongs to a well known prior art to employ a driving circuit incorporating an inverter for changing driving current to be supplied to a light source.

### (2) Second Embodiment

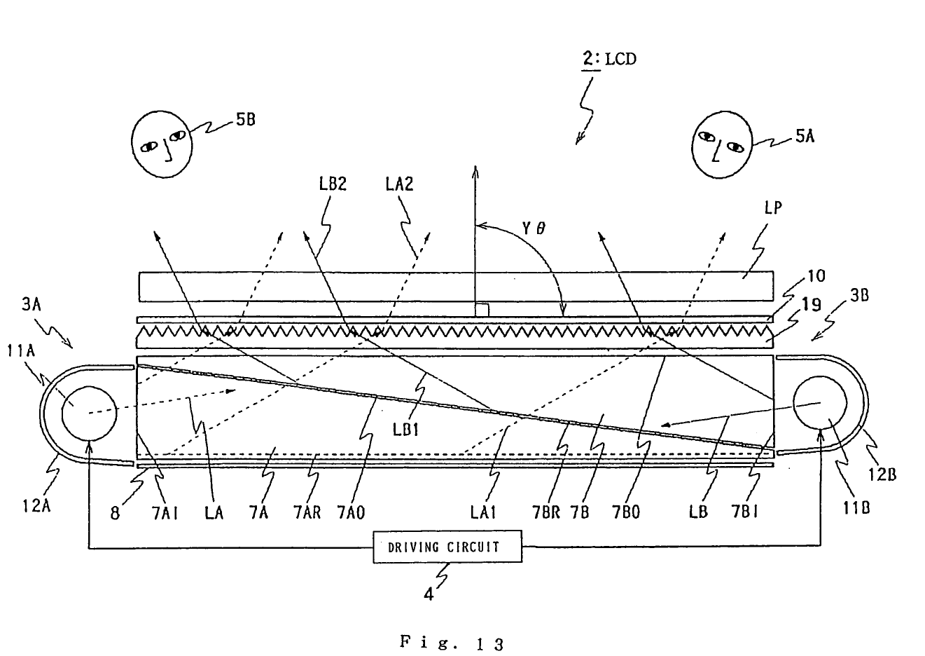

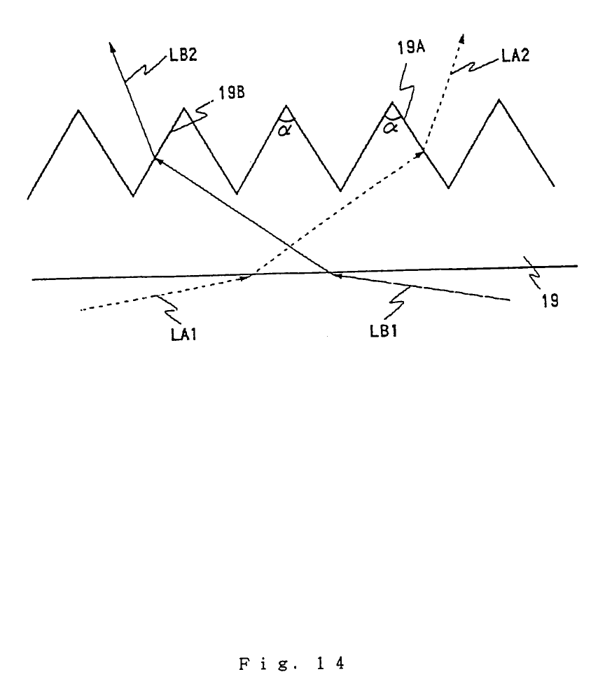

Referring to FIGS. 12 and 13, an arrangement in accordance with the second embodiment is illustrated. As understood by comparing FIGS. 12 and 13 with FIGS. 1 and 2, this arrangement is the same as shown in FIGS. 1 and 2 except that a prism sheet 19 is employed as a light control member instead of the prism sheet 9. Although the prism sheet 19 may be the same as the prism sheet 9, the prism sheet 19 is differently orientated from the prism sheet 9 as described later.

Accordingly, description on the present embodiment is focused to matters related to the prism sheet 19, with matters common to the first embodiment being described simply. And members employed commonly with the first embodiment are indicated by common reference symbols.

In the same way as in the first embodiment (FIGS. 1 and 2), a surface light source device of side light type 1 is disposed for backlighting of a LCD panel LP to constitute a liquid crystal display 2 (FIG. 13). The liquid crystal display 2 is applied, for example, to a display in car navigation system.

The surface light source device 1 comprises first and second guide plates 7A, 7B as well as first and second primary light sources 3A, 3B, correspondingly, with a driving circuit 4 to drive the light sources.

The first and second guide plates have the same wedge-like cross sections and are arranged so that an emission face 7AO extends along a back face 7BR. The the emission face 7AO and the back face 7BR provide slopes of approximately the same area, which are disposed face to face across a thin air layer. Such an arrangement gives compactibility and uniform thickness to the overall structure.

A minor face of the first guide plate 7A provides a first incidence end face 7AI; and a minor face of the second guide plate 7B provides a second incidence end face 7B1, as indicated with circle B in FIG. 12. The first incidence end face 7AI and the second incidence end face 7B1 are located oppositely to each other across both guide plates.

Structure, arrangement and functions of the primary light sources 3A, 3B and the driving circuit 4 are common to those of the first embodiment. The driving circuit 4 is equipped with an inverter and supply one or both of a rod-like fluorescent lamps 11A, 11B with electric power. Power supply is variable continuously or discretely. One of the lamps is optionally to be in turned-on-state with the other lamp being in turned-off-state while both lamps are allowed to be in turned-on-state or to be in turned-off-state.

The fluorescent lamp 11A is disposed along the incidence end face 7AI and the fluorescent lamp 11B is disposed along the incidence end face 7B1. One or both of the fluorescent lamps 11A, 11B supply one or both of the guide plates 7A, 7B with primary light depending on operation mode of the driving circuit 4.

As indicated with circle A in FIG. 12, the back face of the guide plate 7A is provided with a great number of projection rows. Each of the projection rows includes a pair of slopes running approximately at right angles with respect to the incidence end face 7AI. The projection rows function in the same way as in the case of the first embodiment. That is, directivity (preferential emitting direction) of illumination output from the emission face 7AO (accordingly, from the emission face 7BO) is gathered toward a frontal direction regarding in a plane parallel with the incidence end face 7AI.

Besides, improvement in efficiency of emission from the emission face 7AO is realized and light transfer to the guide plate 7B is performed well.

A reflection sheet 8 disposed along the back face 7AR reflects light which has leaked from the back face 7AR to return light into the guide plate 7A, thereby preventing loss of light energy.

Scattering pattern for promoting emission from the guide plate 7A or 7B is formed preferably on one or both of the emission faces 7AO and 7BO. Details of such scattering pattern have been discussed already in the description on the first embodiment.

So far as before impinging onto the prism sheet 19, behaviour of light is the same as in the case of first embodiment under any one of modes, sole turning-on of the fluorescent lamp 11A, sole turning-on of the fluorescent lamp 11B and turning-on of both fluorescent lamps 11A, 11B.

On sole lighting of the fluorescent lamp 11A, illumination light LA is introduced into the guide plate 7A and transferred to the guide plate 7B via various routes, being emitted from the emission face 7AO. As previously discussed, directivity (preferential emitting direction) of illumination output from the emission face 7AO is gathered toward a frontal direction regarding in a plane parallel with the incidence end face 7AI; and it is inclined greatly forward (i. e. toward the incidence end face 7BI) regarding in a plane perpendicular to the incidence end face 7AI.

And, on sole lighting of the fluorescent lamp 11B, illumination light LB is introduced into the guide plate 7B, being emitted from the emission face 7AO via various routes. Thus illumination light LB1 is emitted from the emission face 7BO toward directions greatly inclined with respect to the emission face 7BO forward (i. e. toward the incidence end face 7AI) regarding in a plane perpendicular to the incidence end face 7BI.

That is, at emitting from the emission face 7BO, the representative beams LA1 and LB1 are greatly inclined oppositely to each other with respect to a normal to the emission face 7BO (i. e. with respect to a frontal direction) regarding in a plane perpendicular to the incidence end face 7AI or 7BI. As aforesaid, the beams LA1 and LB1 in this example have inclination angles of about 23 degrees with respect to the emission face 7BO.

According to a feature of the present embodiment, the beams LA1, LB1 become beams LA2 and LB2 which propagate toward different directions from each other after transmitting through the prism sheet 19.

The surface light source device 1 outputs the beam LA2 during sole lighting of the fluorescent lamp 11A and outputs the beam LB2 during sole lighting of the fluorescent lamp 11B, outputting both beams LA2 and during lighting of both fluorescent lamps 11A, 11B.

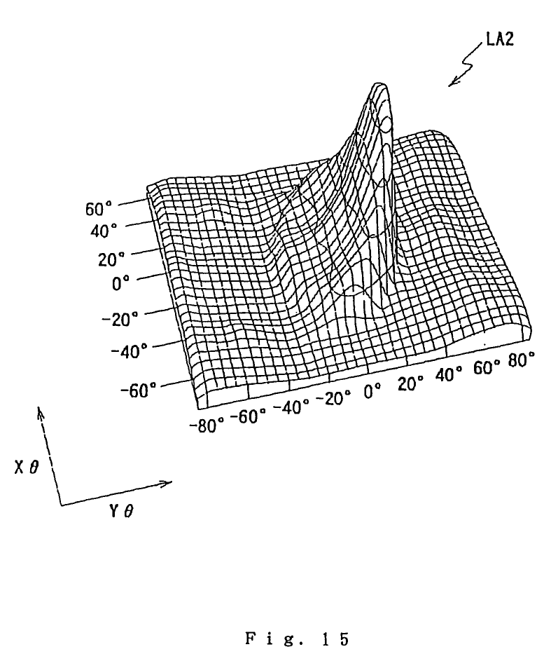

Directivity of emission represented by LA1 and LB1 has been described already with referring to FIGS. 3 to 5. That is, as understood from the measurement results shown in FIGS. 3 and 4, directivity of illumination light represented by LA1 is inclined toward the right hand in FIG. 14 while directivity of illumination light represented by LB1 is inclined toward the left hand in FIG. 14.

As illustrated in FIG. 5, two ridge-like hills appear around angular positions which are symmetrically opposite with respect to a frontal direction (X θ=0), respectively. One ridge corresponds to LA1 and the other ridge corresponds to LB1.

The prism sheet 19 employed in the present embodiment outputs representative beams LA2 and LB2 as illustrated in FIG. 14 through causing the representative beams LA1 and LB1 to be deflected to directions which are deviated from the frontal direction (X θ=0), respectively; propagation directions of the illustrated representative beams LA2 and LB2 are approximately symmetric with respect to the frontal direction.

The prism sheet 19 is, for example, a light permeable sheet-like member made of polycarbonate, like the prism sheet 19. The prism sheet 19 is disposed along the second emission face 7BO with orientation such that a prism face is directed to the outside (directed to a diffusion plate 10). The prism face is provided with a great number of projection rows.

As indicated with circle C in FIG. 12, each of the projection rows includes a pair of slopes 19A, 19B running approximately in parallel with respect to the incidence end face 7B1. Each pair of slopes are directly connected to give a triangular-like cross section to each projection row.

In this embodiment, prism vertical angle is set at about 66 degrees. Inclination angles of (angles with respect to a general plane representing the prism sheet 19) of the slopes 19A, 19B are equal to each other (inclination angles=57 degrees). In other words, the prism sheet 19 has prism vertical angel equal to that of the prism sheet 9. However, it should be noted that this is not a general requirement and the prism sheet 19 may be different from the prism sheet 9 in prism vertical angle.

As illustrated in FIG. 14, illumination light LA1 is introduced into the prism sheet 19 through a flat inner face. Propagation direction of LA1 get up a little owing to refraction. Then illumination output light LA2 is outputted from a slope 19A. Propagation direction of LA2 get up a little again owing to refraction.

On the other hand, illumination light LB1 is introduced into the prism sheet 19 through a flat inner face. Propagation direction of LB1 get up a little owing to refraction. Then illumination output light LB2 is outputted from a slope 19B. Propagation direction of LB2 get up a little again owing to refraction. Comparing propagation directions of LA2 and LB2 with those of LA1 and LB1, modification is effected so that propagation directions are get closer to the frontal direction from both sides.

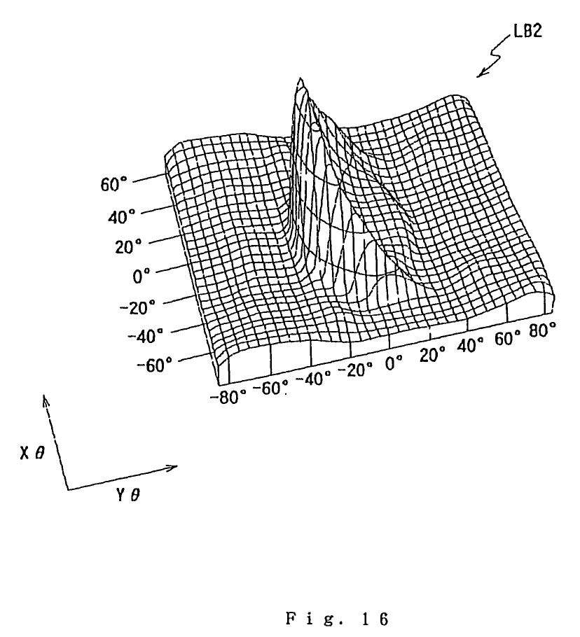

Functions of the prism sheet 19 employed in the present case are understood well from the graphs shown in FIGS. 15 to 17. FIG. 15 is a graph illustrating directional characteristics of illumination light measured under a condition such that the fluorescent lamp 11A (first primary light source) is turned on solely in the second embodiment. In other words, directional characteristics of output light of the prism sheet 19 is measured after the prism sheet 19 is added to the arrangement which has provided the results as shown in FIG. 3.

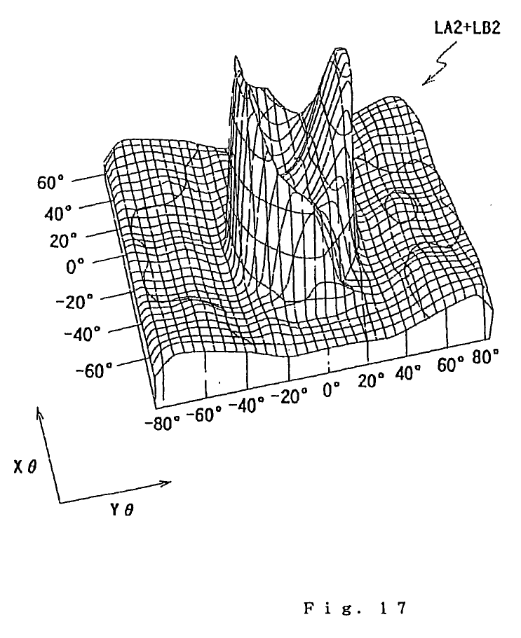

In a similar way, FIG. 16 is a graph illustrating directional characteristics of illumination light measured under a condition such that the fluorescent lamp 11B (second primary light source) is turned on solely in the second embodiment. That is, directional characteristics of output light of the prism sheet 19 is measured after the prism sheet 19 is added to the arrangement which has provided the results as shown in FIG. 4.

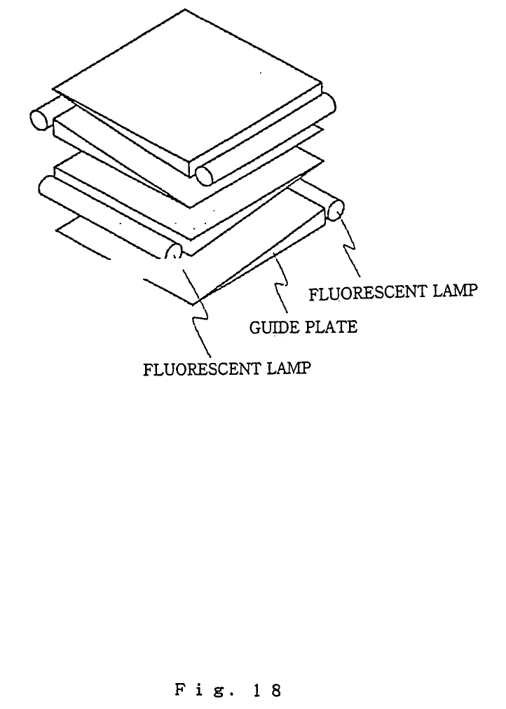

And FIG. 17 is a graph illustrating directional characteristics of illumination light measured under a condition such that both fluorescent lamps 11A, 11B (first and second primary light sources) are turned on in the second embodiment. That is, directional characteristics of output light of the prism sheet 19 is measured after the prism sheet 19 is added to the arrangement which has provided the results as shown in FIG. 5.

It is understood from FIGS. 15 and 16 that illumination output light represented by LA2 has directivity inclined to the right hand in FIG. 13 while illumination output light represented by LB2 has directivity inclined to the left hand in FIG. 13. This is also understood from two ridge-like hills illustrated in the graph of FIG. 17. Needless to say, the graph of FIG. 17 corresponds to the sum of the graphs of FIGS. 15 and 16.

It should be noted that two ridge-like hills illustrated in FIG. 17 get closer to the frontal direction (X θ=0) as compared with two ridge-like hills illustrated in FIG. 5. One ridge in FIG. 17 corresponds to LA2 and the other to LB2.

Thus produced illumination light LA2, LB2 is supplied to the liquid crystal display panel LP after being weakly diffused by the diffusion sheet 10, contributing to displaying. It is important that one or two viewing directions from which bright image is observed are obtained depending on lighting modes because LA2 and LB2 are different from each other in directivity.

When the fluorescent lamp 11A is solely turned on, a direction of an observer 5A is suitable for viewing because illumination light LB2 is not produced. On the other hand, when the fluorescent lamp 11B is solely turned on, another direction of another observer 5B is suitable for viewing because illumination light LA2 is not produced. And it is needless to say that lighting of both fluorescent lamps 11A and 11B provides directions of the observers 5A and 5B which are suitable for viewing.

If the liquid crystal display 2 is applied to a car navigation system, output directions of LA2 and LB2 are designed preferably under a provision such that the observers 5A and 5B are a driver and an assistant, respectively.

In this case, sole lighting of the fluorescent lamp 11A (or 11B) will be reasonable if the LCD screen is viewed solely by the driver; effectiveness of one of two ways of preferential emission is enough. Sole lighting of the fluorescent lamp 11B (or 11A) will be reasonable if the LCD screen is viewed solely by the assistant. And lighting of both fluorescent lamps 11A and 11B is reasonable if the LCD screen is viewed by both of the driver and the assistant.

### (3) Modifications

None of the above-described embodiments limit the scope of the present invention. For instance, the following modifications are allowed.

(a) In the above-described embodiments, projection rows are formed on the back face of the lower guide plate while the back face of the upper guide plate is specular. However, this puts no limitation onto the scope of the present invention. Both of the back faces may be provided with projection rows. Alternatively, both of the back faces may be specular. And, projection rows may be formed on the emission face of the upper guide plate or that of the lower guide plate.

(b) Light diffusion pattern formed on one of both of the respective emission faces of the guide plates may be formed by means of methods other than aforesaid methods, for example, by means of partial printing of white ink. According to an allowed design, none of the guide plates has diffusion pattern. Light diffusion pattern may be formed on one of both of the respective back faces of the guide plates. Further, an emission face and a back face may be provided with light diffusion pattern.

(c) Guide plates may be made of scattering-guiding material other than those employed in the above-described embodiments. Transparent resin having no scattering power inside may be employed.

(d) In the above-describe embodiments, one fluorescent lamp is allotted to each guide plate. However, according to an allowed arrangement, a plurality of light source elements supply each guide plate with primary light.

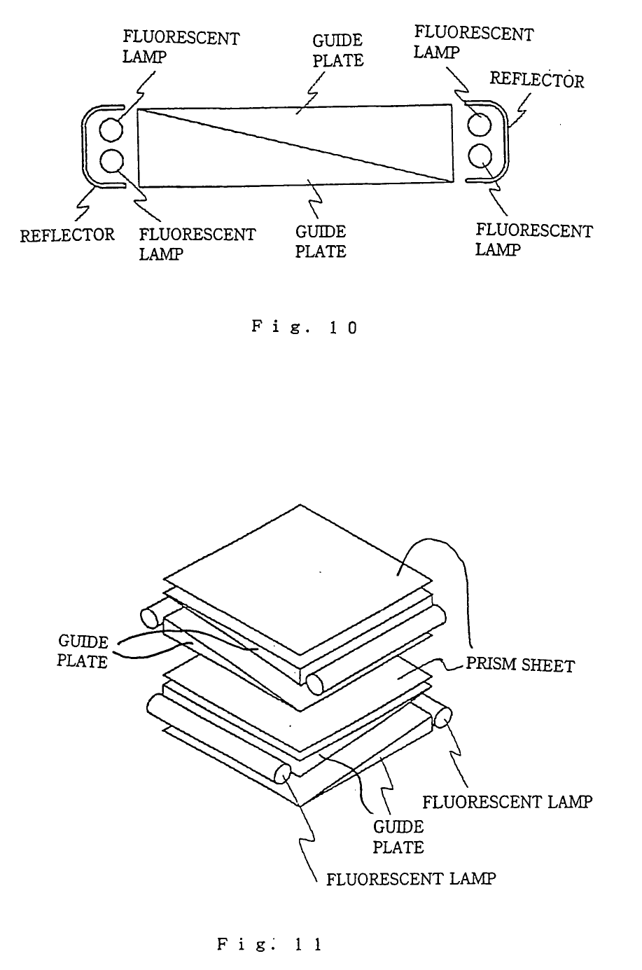

This is exemplified in FIG. 10. In the illustrated example, two rod-like fluorescent lamps are allotted to each of two wedge-like guide plates. Each fluorescent lamp is backed by a reflector and disposed along a thicker end face of each corresponding guide plate to function as a primary light source. Such arrangement will enable luminance to be adjusted over a very wide range because combination of working states of the respective fluorescent lamps is diversified.

Arrangements as shown in this example can be applied to devices of first-embodiment-type (mono-directivity) or second-embodiment-type (dual-directivity) depending on characteristics of the employed prism sheet.

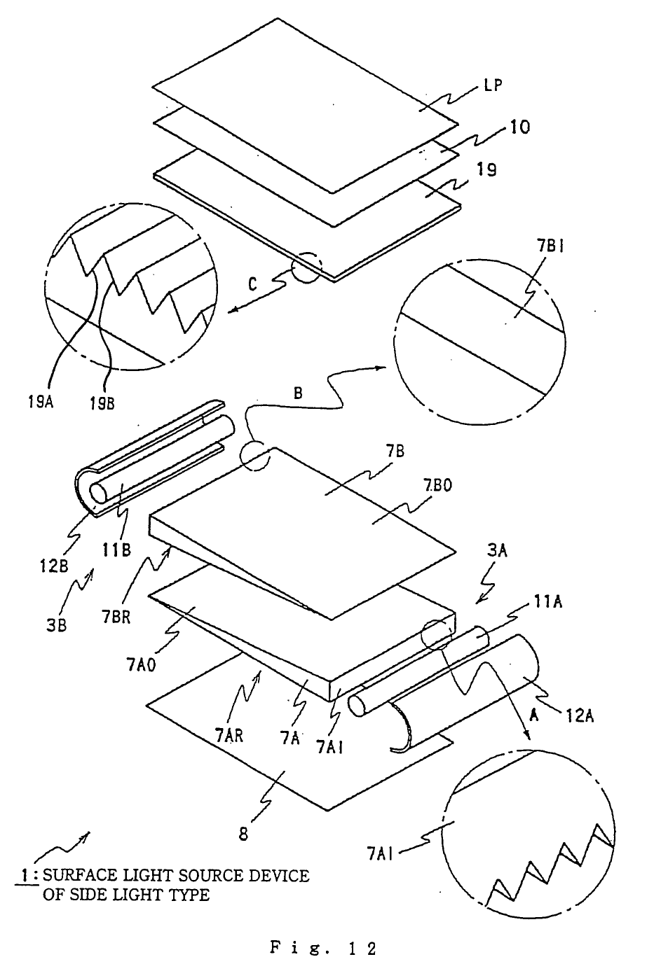

(e) Three or more guide plates may be laminatedly arranged. Examples are illustrated in FIGS. 11 and 18.

According to an example shown in FIG. 11, two units each of which is of first-embodiment-type (mono-directivity) are combinated with orientation such that the units make right angles with each other. This arrangement diversifies realizable combination of working states of the respective fluorescent lamps, thereby enabling luminance to be adjusted over an expanded range.

According to another example shown in FIG. 18, two units are combinated with orientation such that the units make right angles with each other, wherein the units are the same as those employed in the first or second embodiment except that the respective prism sheets are removed.

This arrangement also diversifies realizable combination of working states of the respective fluorescent lamps, thereby enabling directivity to be changed over a very wide range. For instance, Sole lightening of optional one of four fluorescent lamps permits directivity to be aimed at optional one of four directions.

(f) In the above-described embodiments, prism vertical angle of the employed prism sheets is 66 degrees. However, this puts no limitation onto the scope of the present invention.

As previously described, suitable prism vertical angles may be designed and determined depending on required directivity. In general, prism vertical angles may be set at optional values not smaller than 40 degrees and, accordingly, varied characteristics of directivity are realizable.

It should be noted that arrangements employing no prism sheet are allowed. In general, such arrangements will allow directivity to aim at two or more directions depending on numbers of employed guide plates.

(g) Prism face of each prism sheet is directed inward in the first embodiment while directed outward in the second embodiment. In general, prism face is allowed to be directed optionally inward or outward so far as required directivity is given to illumination output light.

Two or more prism sheets may be employed to modify directivity optionally. For example, two prism sheets may be arranged so that the slopes of one prism sheet is perpendicular to that of the slopes of the other prism sheet. In this case, directivity can be modified regarding-in two planes corresponding to two directions (parallel and perpendicular to an incidence end face of guide plate). Alternatively, a so-called both-prism-face prism sheet may be employed.

Projection rows of prism sheet does not necessarily consist of direct connection of slopes. For instance, each projection row may consist of a pair of slopes and curvature bridging the slopes. Alternatively, each projection row may consist of slopes forming curvature themselves.

(h) In the above-described embodiments, a light diffusion]sheet is disposed outside of a prism sheet. However, this puts no limitation to the present invention. For instance, the light diffusion]sheet may be removed. And other elements such as a polarization separation sheet may be disposed.

(i) In the above-described embodiments, guide plates having wedge-like cross section are employed. However, other guide plates may be employed alternatively, so far as supply of primary light through side end faces cause emission faces to provide oblique preferential output mission. For instance, two guide plates having overall uniform thickness may be employed instead of the wedge-like guide plates 7A, 7B employed in the first or second embodiment.

(j) In the above-described embodiments, the present invention is applied to LCDs employed in car navigation system. The present invention may be applied to LCDs for diverse devices such as personal computer. Alternatively, the present invention may be variously applied to illumination devices or displays other than LCD.

1. A surface light source device of side light type comprising:
a first guide plate;
a first primary light source disposed beside the first guide plate;
a second guide plate;
a second primary light source disposed beside the second guide plate; and
a driving circuit to drive the first primary light source and the second primary light source,
said first guide plate having two major faces to provide a first emission face and a first back face and having a minor face to provide a first incidence end face;
said second guide plate having two major faces to provide a second emission face and a second back face and having a minor face to provide a second incidence end face;
said first guide plate and said second guide plate being laminatedly arranged so that said second back face extends along said first emission face; and
said first incidence end face and said second incidence end face being located oppositely to each other across said laminatedly arranged guide plates, wherein
a light control member to control directivity of output illumination light is disposed along said second emission face.

2. A surface light source device of side light type in accordance with claim 1, wherein said driving circuit is capable of turning off only one in said first and second primary light sources.

3. A surface light source device of side light type in accordance with claim 1, wherein said first and second guide plates have wedge-shaped cross sections so that said first and second incidence end faces are located at thicker ends of the cross section, respectively.

4. A surface light source device of side light type in accordance with claim 2, wherein said first and second guide plates have wedge-shaped cross sections so that said first and second incidence end faces are located at thicker ends of the cross sections, respectively.

5. A surface light source device of side light type in accordance with claim 1, wherein said first back face is provided with a great number of projection rows each of which includes a pair of slopes running approximately at right angles with said first incidence end face.

6. A surface light source device of side light type in accordance with claim 2, wherein said first back face is provided with a great number of projection rows each of which includes a pair of slopes running approximately at right angles with said first incidence end face.

7. A surface light source device of side light type in accordance with claim 3, wherein said first back face is provided with a great number of projection rows each of which includes a pair of slopes running approximately at right angles with said first incidence end face.

8. A surface light source device of side light type in accordance with claim 4, wherein said first back face is provided with a great number of projection rows each of which includes a pair of slopes running approximately at right angles with said first incidence end face.

9. A surface light source device of side light type in accordance with claim 1, wherein said light control member modifies directivity of illumination output light so that illumination output light originated from any one of said first and second primary light sources is directed to a frontal direction with respect to said second emission face.

10. A surface light source device of side light type in accordance with claim 9, wherein said light control member has an inner face provided with a great number of projection rows each of which includes a pair of slopes running approximately parallel with said second incidence end face.

11. A surface light source device of side light type in accordance with claim 1, wherein said light control member modifies directivity of illumination output light so that illumination output light originated from said first primary light source and illumination output light originated from said second primary light source are directed to two different directions, respectively.

12. A surface light source device of side light type in accordance with claim 11, wherein said light control member has an outer face provided with a great number of projection rows each of which includes a pair of slopes running approximately parallel with said second incidence end face.

13-22. (canceled)

23. A liquid crystal display in accordance with claim 1, wherein said light control member modifies directivity of illumination output light so that illumination output light originated from said first primary light source and illumination output light originated from said second primary light source are directed to two different directions, respectively.

24. A liquid crystal display in accordance with claim 23, wherein said light control member has an outer face provided with a great number of projection row each of which includes a pair of slopes running approximately parallel with said second incidence end face.
